(19) United States
(12) Patent Application Publication
(10) Pub. No.: US 2023/0267587 A1
(43) Pub. Date: Aug. 24, 2023

(54) TUNING COLOR IMAGE FUSION TOWARDS ORIGINAL INPUT COLOR WITH ADJUSTABLE DETAILS

(71) Applicant: INNOPEAK TECHNOLOGY, INC., Palo Alto, CA (US)

(72) Inventors: Kim C. NG, Palo Alto, CA (US); Jinglin SHEN, Palo Alto, CA (US); Chiuman HO, Palo Alto, CA (US)

(21) Appl. No.: 18/191,128

(22) Filed: Mar. 28, 2023

Related U.S. Application Data
(63) Continuation of application No. PCT/US2021/027417, filed on Apr. 15, 2021.
(60) Provisional application No. 63/113,152, filed on Nov. 12, 2020.

(51) Int. Cl. G06T 5/50

(52) U.S. Cl. CPC G06T 5/50; G06T 2207/20221; G06T 2207/20024

(57) ABSTRACT

A computer system obtains a first image and a second image of a scene, and generates a fused image that combines the first and second images. The fused image is decomposed to a fusion base component and a fusion detail component. The first image is decomposed to a first base component and a first detail component. The computer system combines the first base component of the first image and the fusion detail component of the fused image to a final image.

### CROSS-REFERENCE TO RELATED APPLICATION(S)

This application is a continuation of International Application No. PCT/US2021/027417, filed Apr. 15, 2021, which claims priority to U.S. Provisional Patent Application No. 63/113,152, filed Nov. 12, 2020, the entire disclosures of which are incorporated herein by reference.

### TECHNICAL FIELD

The present application generally relates to image processing, particularly to methods and systems for fusing and tuning images that are captured of a scene by two distinct sensor modalities (visible light and near-infrared image sensors) of a single camera or two distinct cameras in a synchronous manner.

### BACKGROUND

Image fusion techniques are applied to combine information from different image sources into a single image. Resulting images contain more information than that provided by any single image source. The different image sources often correspond to different sensory modalities located in a scene to provide different types of information (e.g., colors, brightness, and details) for image fusion. For example, color images are fused with near-infrared (NIR) images, which enhance details in the color images while substantially preserving color and brightness information of the color images. Particularly, NIR light can travel through fog, smog, or haze better than visible light, allowing some dehazing algorithms to be established based on a combination of the NIR and color images. However, color in resulting images that are fused from the color and NIR images can deviate from true color of the original color images. It would be beneficial to have a mechanism to implement image fusion effectively and improve quality of images resulting from image fusion.

### SUMMARY

In an aspect, an image processing method is provided. The image processing method includes obtaining a first image and a second image of a scene, generating a fused image that combines the first and second images, decomposing the fused image to a fusion base component and a fusion detail component, decomposing the first image to a first base component and a first detail component, and combining the first base component of the first image and the fusion detail component of the fused image to a final image.

In another aspect, a computer system includes one or more processors and a memory having instructions stored thereon. The programs, when executed by the one or more processors, cause the one or more processors to perform the image processing method as described above.

In another aspect, a non-transitory computer-readable storage medium having instructions stored thereon. The programs, when executed by one or more processors, cause the one or more processors to perform the image processing method as described above.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles.

FIG. 1 is an example data processing environment having one or more servers communicatively coupled to one or more client devices, in accordance with some embodiments.

FIG. 2 is a block diagram illustrating a data processing system, in accordance with some embodiments.

FIG. 3 is an example data processing environment for training and applying a neural network based (NN-based) data processing model for processing visual and/or audio data, in accordance with some embodiments.

FIG. 4A is an example neural network applied to process content data in an NN-based data processing model, in accordance with some embodiments, and FIG. 4B is an example node in the neural network, in accordance with some embodiments.

FIG. 5 is an example framework of fusing an RGB image and an NIR image, in accordance with some embodiments.

FIG. 6 is another example framework of fusing two images, e.g., for correcting color of a fused image generated from the two images, in accordance with some embodiments.

FIGS. 7A-7D are an RGB image, an NIR monochrome image, a fused image combining the RGB image and NIR monochrome image, and a final image generated by the framework shown in FIG. 6 in accordance with some embodiments.

FIG. 8 is a flow diagram of an image fusion method implemented at a computer system, in accordance with some embodiments.

FIG. 9 is a flow diagram of another image processing method implemented at a computer system, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

The present application describes embodiments related to combining information of a plurality of images captured by different image sensor modalities, e.g., a true color image (also called an RGB image) and a corresponding NIR image. In an example, the RGB and NIR images can be decomposed into detail portions and base portions and are fused in a radiance domain using different weights. Prior to this fusion process, the RGB and NIR images can be aligned locally and iteratively using an image registration operation. Radiances of the RGB and NIR images may have different dynamic ranges and can be normalized via a radiance mapping function. For image fusion, luminance components of the RGB and NIR images may be combined based on an infrared emission strength, and further fused with color components of the RGB image. A fused image can also be adjusted with reference to one of a plurality of color channels of the fused image. Further, in some embodiments, a base component of the RGB image and a detail component of the fused image are extracted and combined to improve the quality of image fusion. When one or more hazy zones are detected in the fused images, a predefined portion of each hazy zone is saturated to suppress a hazy effect in the fused image. By these means, the image fusion can be implemented effectively, thereby providing images with better image qualities (e.g., having more details, better color fidelity, and/or a lower hazy level).

The present application is directed to combining information of a plurality of images by different mechanisms and applying additional pre-processing and post-processing to improve an image quality of a resulting fused image. In some embodiments, an RGB image and an NIR image can be decomposed into detail portions and base portions and are fused in a radiance domain using different weights. In some embodiments, radiances of the RGB and NIR images may have different dynamic ranges and can be normalized via a radiance mapping function. For image fusion, in some embodiments, luminance components of the RGB and NIR images may be combined based on an infrared emission strength, and further fused with color components of the RGB image. In some embodiments, a fused image can also be adjusted with reference to one of a plurality of color channels of the fused image. In some embodiments, a base component of the RGB image and a detail component of the fused image are extracted and combined to improve the quality of image fusion. Prior to any fusion process, the RGB and NIR images can be aligned locally and iteratively using an image registration operation. Further, when one or more hazy zones are detected in an input RGB image or a fused image, white balance is adjusted locally by saturating a predefined portion of each hazy zone to suppress a hazy effect in the RGB or fused image. By these means, the image fusion can be implemented effectively, thereby providing images with better image qualities (e.g., having more details, better color fidelity, and/or a lower hazy level).

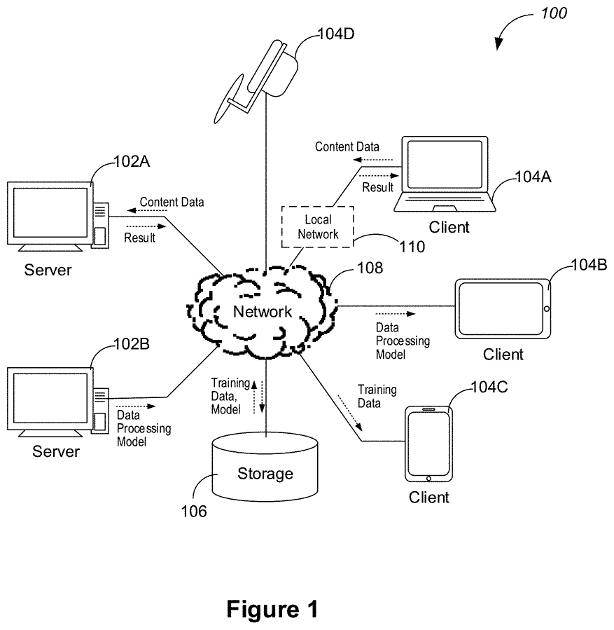

FIG. 1 is an example data processing environment 100 having one or more servers 102 communicatively coupled to one or more client devices 104, in accordance with some embodiments. The one or more client devices 104 may be, for example, desktop computers 104A, tablet computers 104B, mobile phones 104C, or intelligent, multi-sensing, network-connected home devices (e.g., a surveillance camera 104D). Each client device 104 can collect data or user inputs, executes user applications, or present outputs on its user interface. The collected data or user inputs can be processed locally at the client device 104 and/or remotely by the server(s) 102. The one or more servers 102 provides system data (e.g., boot files, operating system images, and user applications) to the client devices 104, and in some embodiments, processes the data and user inputs received from the client device(s) 104 when the user applications are executed on the client devices 104. In some embodiments, the data processing environment 100 further includes a storage 106 for storing data related to the servers 102, client devices 104, and applications executed on the client devices 104.

The one or more servers 102 can enable real-time data communication with the client devices 104 that are remote from each other or from the one or more servers 102. In some embodiments, the one or more servers 102 can implement data processing tasks that cannot be or are preferably not completed locally by the client devices 104. For example, the client devices 104 include a game console that executes an interactive online gaming application. The game console receives a user instruction and sends it to a game server 102 with user data. The game server 102 generates a stream of video data based on the user instruction and user data and providing the stream of video data for concurrent display on the game console and other client devices 104 that are engaged in the same game session with the game console. In another example, the client devices 104 include a mobile phone 104C and a networked surveillance camera 104D. The camera 104D collects video data and streams the video data to a surveillance camera server 102 in real time. While the video data is optionally pre-processed on the camera 104D, the surveillance camera server 102 processes the video data to identify motion or audio events in the video data and share information of these events with the mobile phone 104C, thereby allowing a user of the mobile phone 104C to monitor the events occurring near the networked surveillance camera 104D in real time and remotely.

The one or more servers 102, one or more client devices 104, and storage 106 are communicatively coupled to each other via one or more communication networks 108, which are the medium used to provide communications links between these devices and computers connected together within the data processing environment 100. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 108 may be established either directly (e.g., using 3G/4G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, deep learning techniques are applied in the data processing environment 100 to process content data (e.g., video, image, audio, or textual data) obtained by an application executed at a client device 104 to identify information contained in the content data, match the content data with other data, categorize the content data, or synthesize related content data. In these deep learning techniques, data processing models are created based on one or more neural networks to process the content data. These data processing models are trained with training data before they are applied to process the content data. In some embodiments, both model training and data processing are implemented locally at each individual client device 104 (e.g., the client device 104C). The client device 104C obtains the training data from the one or more servers 102 or storage 106 and applies the training data to train the data processing models. Subsequently to model training, the client device 104C obtains the content data (e.g., captures video data via an internal camera) and processes the content data using the training data processing models locally. Alternatively, in some embodiments, both model training and data processing are implemented remotely at a server 102 (e.g., the server 102A) associated with one or more client devices 104 (e.g. the client devices 104A and 104D). The server 102A obtains the training data from itself, another server 102 or the storage 106 and applies the training data to train the data processing models. The client device 104A or 104D obtains the content data and sends the content data to the server 102A (e.g., in a user application) for data processing using the trained data processing models. The same client device or a distinct client device 104A receives data processing results from the server 102A, and presents the results on a user interface (e.g., associated with the user application). The client device 104A or 104D itself implements no or little data processing on the content data prior to sending them to the server 102A. Additionally, in some embodiments, data processing is implemented locally at a client device 104 (e.g., the client device 104B), while model training is implemented remotely at a server 102 (e.g., the server 102B) associated with the client device 104B. The server 102B obtains the training data from itself, another server 102 or the storage 106 and applies the training data to train the data processing models. The trained data processing models are optionally stored in the server 102B or storage 106. The client device 104B imports the trained data processing models from the server 102B or storage 106, processes the content data using the data processing models, and generates data processing results to be presented on a user interface locally.

In various embodiments of this application, distinct images are captured by a camera (e.g., a standalone surveillance camera 104D or an integrated camera of a client device 104A), and processed in the same camera, the client device 104A containing the camera, a server 102, or a distinct client device 104. Optionally, deep learning techniques are trained or applied for the purposes of processing the images. In an example, a near infrared (NIR) image and an RGB image are captured by the camera 104D or the camera of the client device 104A. After obtaining the NIR and RGB image, the same camera 104D, client device 104A containing the camera, server 102, distinct client device 104 or a combination of them normalizes the NIR and RGB images, converts the images to a radiance domain, decomposes the images to different portions, combines the decomposed portions, tunes color of a fused image, and/or dehazes the fused image, optionally using a deep learning technique. The fused image can be reviewed on the client device 104A containing the camera or the distinct client device 104.

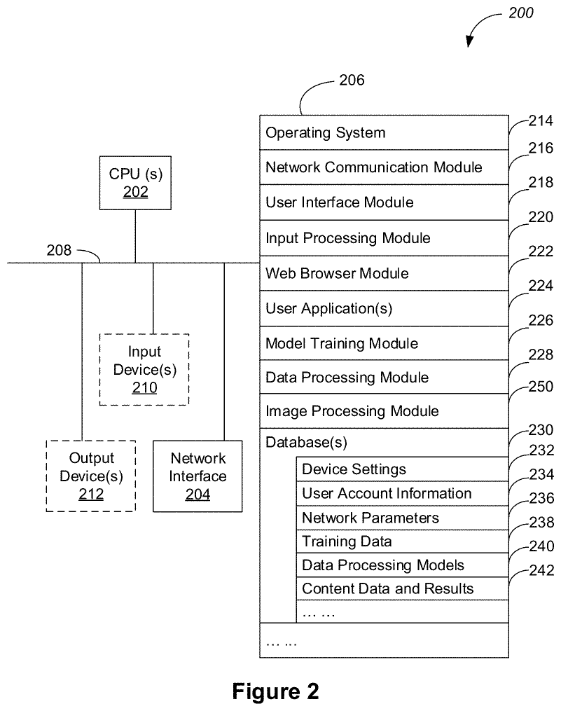

FIG. 2 is a block diagram illustrating a data processing system 200, in accordance with some embodiments. The data processing system 200 includes a server 102, a client device 104, a storage 106, or a combination thereof. The data processing system 200, typically, includes one or more processing units (CPUs) 202, one or more network interfaces 204, memory 206, and one or more communication buses 208 for interconnecting these components (sometimes called a chipset). The data processing system 200 includes one or more input devices 210 that facilitate user input, such as a keyboard, a mouse, a voice-command input unit or microphone, a touch screen display, a touch-sensitive input pad, a gesture capturing camera, or other input buttons or controls. Furthermore, in some embodiments, the client device 104 of the data processing system 200 uses a microphone and voice recognition or a camera and gesture recognition to supplement or replace the keyboard. In some embodiments, the client device 104 includes one or more cameras, scanners, or photo sensor units for capturing images, for example, of graphic serial codes printed on the electronic devices. The data processing system 200 also includes one or more output devices 212 that enable presentation of user interfaces and display content, including one or more speakers and/or one or more visual displays. Optionally, the client device 104 includes a location detection device, such as a GPS (global positioning satellite) or other geo-location receiver, for determining the location of the client device 104.

Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 202. Memory 206, or alternatively the non-volatile memory within memory 206, includes a non-transitory computer readable storage medium. In some embodiments, memory 206, or the non-transitory computer readable storage medium of memory 206, stores the following programs, modules, and data structures, or a subset or superset thereof:
Operating system 214 including procedures for handling various basic system services and for performing hardware dependent tasks;
Network communication module 216 for connecting each server 102 or client device 104 to other devices (e.g., server 102, client device 104, or storage 106) via one or more network interfaces 204 (wired or wireless) and one or more communication networks 108, such as the Internet, other wide area networks, local area networks, metropolitan area networks, and so on;
User interface module 218 for enabling presentation of information (e.g., a graphical user interface for application(s) 224, widgets, websites and web pages thereof, and/or games, audio and/or video content, text, etc.) at each client device 104 via one or more output devices 212 (e.g., displays, speakers, etc.);
Input processing module 220 for detecting one or more user inputs or interactions from one of the one or more input devices 210 and interpreting the detected input or interaction;
Web browser module 222 for navigating, requesting (e.g., via HTTP), and displaying websites and web pages thereof, including a web interface for logging into a user account associated with a client device 104 or another electronic device, controlling the client or electronic device if associated with the user account, and editing and reviewing settings and data that are associated with the user account;
One or more user applications 224 for execution by the data processing system 200 (e.g., games, social network applications, smart home applications, and/or other web or non-web based applications for controlling another electronic device and reviewing data captured by such devices);
Model training module 226 for receiving training data and establishing a data processing model for processing content data (e.g., video, image, audio, or textual data) to be collected or obtained by a client device 104;
Data processing module 228 for processing content data using data processing models 240, thereby identifying information contained in the content data, matching the content data with other data, categorizing the content data, enhancing the content data, or synthesizing related content data, where in some embodiments, the data processing module 228 is associated with one of the user applications 224 to process the content data in response to a user instruction received from the user application 224;
Image processing module 250 for normalizing an NIR image and an RGB image, converting the images to a radiance domain, decomposing the images to different portions, combining the decomposed portions, and/or tuning a fused image, where in some embodiments, one or more image processing operations involve deep learning techniques and are implemented jointly with the model training module 226 or data processing module 228; and
One or more databases 230 for storing at least data including one or more of:
   Device settings 232 including common device settings (e.g., service tier, device model, storage capacity, processing capabilities, communication capabilities, Camera Response Functions (CRFs), etc.) of the one or more servers 102 or client devices 104;
   User account information 234 for the one or more user applications 224, e.g., user names, security questions, account history data, user preferences, and predefined account settings;
   Network parameters 236 for the one or more communication networks 108, e.g., IP address, subnet mask, default gateway, DNS server and host name;
   Training data 238 for training one or more data processing models 240;
   Data processing model(s) 240 for processing content data (e.g., video, image, audio, or textual data) using deep learning techniques; and
   Content data and results 242 that are obtained by and outputted to the client device 104 of the data processing system 200, respectively, where the content data is processed locally at a client device 104 or remotely at a server 102 or a distinct client device 104 to provide the associated results 242 to be presented on the same or distinct client device 104, and examples of the content data and results 242 include RGB images, NIR images, fused images, and related data (e.g., depth images, infrared emission strengths, feature points of the RGB and NIR images, fusion weights, and a predefined percentage and a low-end pixel value end set for localized auto white balance adjustment, etc.).

Optionally, the one or more databases 230 are stored in one of the server 102, client device 104, and storage 106 of the data processing system 200. Optionally, the one or more databases 230 are distributed in more than one of the server 102, client device 104, and storage 106 of the data processing system 200. In some embodiments, more than one copy of the above data is stored at distinct devices, e.g., two copies of the data processing models 240 are stored at the server 102 and storage 106, respectively.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 206, optionally, stores a subset of the modules and data structures identified above. Furthermore, memory 206, optionally, stores additional modules and data structures not described above.

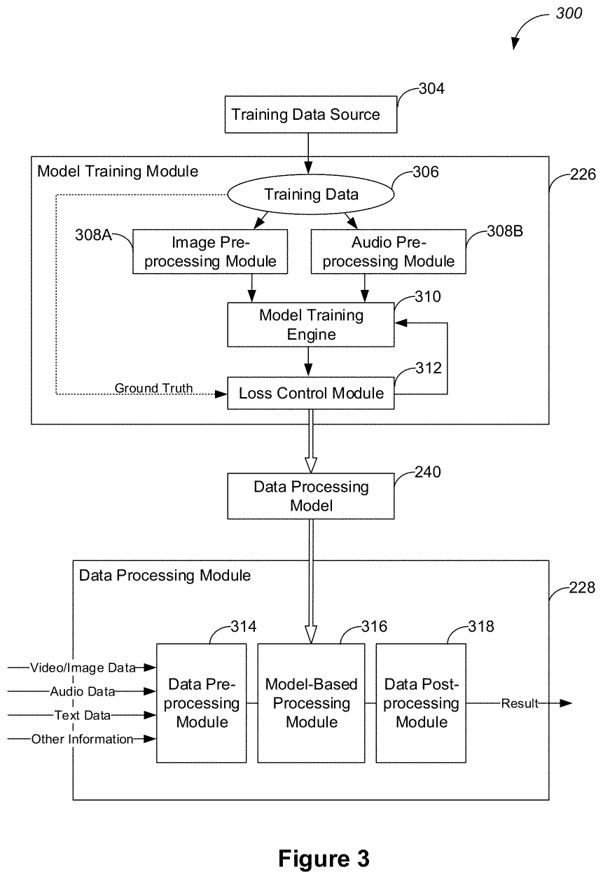

FIG. 3 is another example data processing system 300 for training and applying a neural network based (NN-based) data processing model 240 for processing content data (e.g., video, image, audio, or textual data), in accordance with some embodiments. The data processing system 300 includes a model training module 226 for establishing the data processing model 240 and a data processing module 228 for processing the content data using the data processing model 240. In some embodiments, both of the model training module 226 and the data processing module 228 are located on a client device 104 of the data processing system 300, while a training data source 304 distinct form the client device 104 provides training data 306 to the client device 104. The training data source 304 is optionally a server 102 or storage 106. Alternatively, in some embodiments, both of the model training module 226 and the data processing module 228 are located on a server 102 of the data processing system 300. The training data source 304 providing the training data 306 is optionally the server 102 itself, another server 102, or the storage 106. Additionally, in some embodiments, the model training module 226 and the data processing module 228 are separately located on a server 102 and client device 104, and the server 102 provides the trained data processing model 240 to the client device 104.

The model training module 226 includes one or more data pre-processing modules 308, a model training engine 310, and a loss control module 312. The data processing model 240 is trained according to a type of the content data to be processed. The training data 306 is consistent with the type of the content data, so is a data pre-processing module 308 applied to process the training data 306 consistent with the type of the content data. For example, an image pre-processing module 308A is configured to process image training data 306 to a predefined image format, e.g., extract a region of interest (ROI) in each training image, and crop each training image to a predefined image size. Alternatively, an audio pre-processing module 308B is configured to process audio training data 306 to a predefined audio format, e.g., converting each training sequence to a frequency domain using a Fourier transform. The model training engine 310 receives pre-processed training data provided by the data pre-processing modules 308, further processes the pre-processed training data using an existing data processing model 240, and generates an output from each training data item. During this course, the loss control module 312 can monitor a loss function comparing the output associated with the respective training data item and a ground truth of the respective training data item. The model training engine 310 modifies the data processing model 240 to reduce the loss function, until the loss function satisfies a loss criteria (e.g., a comparison result of the loss function is minimized or reduced below a loss threshold). The modified data processing model 240 is provided to the data processing module 228 to process the content data.

In some embodiments, the model training module 226 offers supervised learning in which the training data is entirely labelled and includes a desired output for each training data item (also called the ground truth in some situations). Conversely, in some embodiments, the model training module 226 offers unsupervised learning in which the training data are not labelled. The model training module 226 is configured to identify previously undetected patterns in the training data without pre-existing labels and with no or little human supervision. Additionally, in some embodiments, the model training module 226 offers partially supervised learning in which the training data are partially labelled.

The data processing module 228 includes a data pre-processing modules 314, a model-based processing module 316, and a data post-processing module 318. The data pre-processing modules 314 pre-processes the content data based on the type of the content data. Functions of the data pre-processing modules 314 are consistent with those of the pre-processing modules 308 and covert the content data to a predefined content format that is acceptable by inputs of the model-based processing module 316. Examples of the content data include one or more of: video, image, audio, textual, and other types of data. For example, each image is pre-processed to extract an ROI or cropped to a predefined image size, and an audio clip is pre-processed to convert to a frequency domain using a Fourier transform. In some situations, the content data includes two or more types, e.g., video data and textual data. The model-based processing module 316 applies the trained data processing model 240 provided by the model training module 226 to process the pre-processed content data. The model-based processing module 316 can also monitor an error indicator to determine whether the content data has been properly processed in the data processing model 240. In some embodiments, the processed content data is further processed by the data post-processing module 318 to present the processed content data in a preferred format or to provide other related information that can be derived from the processed content data.

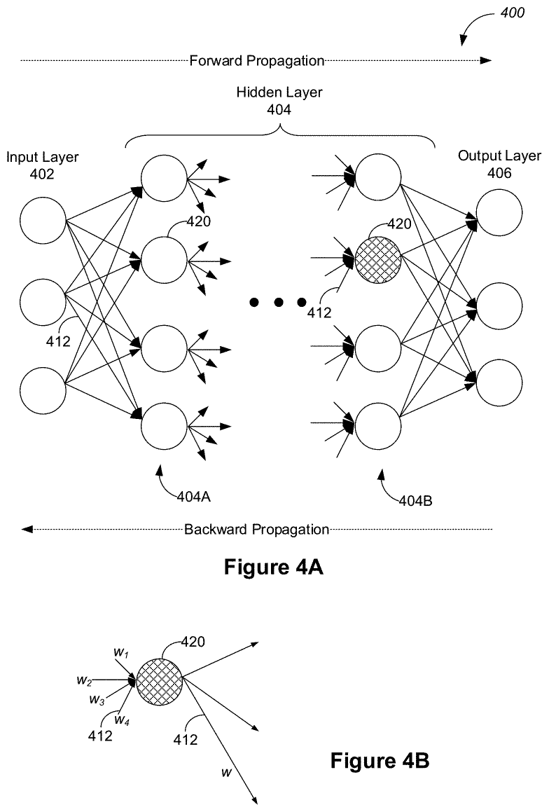

FIG. 4A is an example neural network (NN) 400 applied to process content data in an NN-based data processing model 240, in accordance with some embodiments, and FIG. 4B is an example node 420 in the neural network (NN) 400, in accordance with some embodiments. The data processing model 240 is established based on the neural network 400. A corresponding model-based processing module 316 applies the data processing model 240 including the neural network 400 to process content data that has been converted to a predefined content format. The neural network 400 includes a collection of nodes 420 that are connected by links 412. Each node 420 receives one or more node inputs and applies a propagation function to generate a node output from the one or more node inputs. As the node output is provided via one or more links 412 to one or more other nodes 420, a weight w associated with each link 412 is applied to the node output. Likewise, the one or more node inputs are combined based on corresponding weights w₁, w₂, w₃, and w₄ according to the propagation function. In an example, the propagation function is a product of a non-linear activation function and a linear weighted combination of the one or more node inputs.

The collection of nodes 420 is organized into one or more layers in the neural network 400. Optionally, the one or more layers includes a single layer acting as both an input layer and an output layer. Optionally, the one or more layers includes an input layer 402 for receiving inputs, an output layer 406 for providing outputs, and zero or more hidden layers 404 (e.g., 404A and 404B) between the input and output layers 402 and 406. A deep neural network has more than one hidden layers 404 between the input and output layers 402 and 406. In the neural network 400, each layer is only connected with its immediately preceding and/or immediately following layer. In some embodiments, a layer 402 or 404B is a fully connected layer because each node 420 in the layer 402 or 404B is connected to every node 420 in its immediately following layer. In some embodiments, one of the one or more hidden layers 404 includes two or more nodes that are connected to the same node in its immediately following layer for down sampling or pooling the nodes 420 between these two layers. Particularly, max pooling uses a maximum value of the two or more nodes in the layer 404B for generating the node of the immediately following layer 406 connected to the two or more nodes.

In some embodiments, a convolutional neural network (CNN) is applied in a data processing model 240 to process content data (particularly, video and image data). The CNN employs convolution operations and belongs to a class of deep neural networks 400, i.e., a feedforward neural network that only moves data forward from the input layer 402 through the hidden layers to the output layer 406. The one or more hidden layers of the CNN are convolutional layers convolving with a multiplication or dot product. Each node in a convolutional layer receives inputs from a receptive area associated with a previous layer (e.g., five nodes), and the receptive area is smaller than the entire previous layer and may vary based on a location of the convolution layer in the convolutional neural network. Video or image data is pre-processed to a predefined video/image format corresponding to the inputs of the CNN. The pre-processed video or image data is abstracted by each layer of the CNN to a respective feature map. By these means, video and image data can be processed by the CNN for video and image recognition, classification, analysis, imprinting, or synthesis.

Alternatively and additionally, in some embodiments, a recurrent neural network (RNN) is applied in the data processing model 240 to process content data (particularly, textual and audio data). Nodes in successive layers of the RNN follow a temporal sequence, such that the RNN exhibits a temporal dynamic behavior. In an example, each node 420 of the RNN has a time-varying real-valued activation. Examples of the RNN include, but are not limited to, a long short-term memory (LSTM) network, a fully recurrent network, an Elman network, a Jordan network, a Hopfield network, a bidirectional associative memory (BAM network), an echo state network, an independently RNN (IndRNN), a recursive neural network, and a neural history compressor. In some embodiments, the RNN can be used for handwriting or speech recognition. It is noted that in some embodiments, two or more types of content data are processed by the data processing module 228, and two or more types of neural networks (e.g., both CNN and RNN) are applied to process the content data jointly.

The training process is a process for calibrating all of the weights w₁ for each layer of the learning model using a training data set which is provided in the input layer 402. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured, and the weights are adjusted accordingly to decrease the error. The activation function is optionally linear, rectified linear unit, sigmoid, hyperbolic tangent, or of other types. In some embodiments, a network bias term b is added to the sum of the weighted outputs from the previous layer before the activation function is applied. The network bias b provides a perturbation that helps the NN 400 avoid over fitting the training data. The result of the training includes the network bias parameter b for each layer.

Image Fusion is to combine information from different image sources into a compact form of image that contains more information than any single source image. In some embodiments, image fusion is based on different sensory modalities of the same camera or two distinct cameras, and the different sensory modalities contain different types of information, including color, brightness, and detail information. For example, color images (RGB) are fused with NIR images, e.g., using deep learning techniques, to incorporate details of the NIR images into the color images while preserving the color and brightness information of the color images. A fused image incorporates more details from a corresponding NIR image and has a similar RGB look to a corresponding color image. Various embodiments of this application can achieve a high dynamic range (HDR) in a radiance domain, optimize amount of details incorporated from the NIR images, prevent a see-through effect, preserve color of the color images, and dehaze the color or fused images. As such, these embodiments can be widely used for different applications including, but not limited to, autonomous driving and visual surveillance applications.

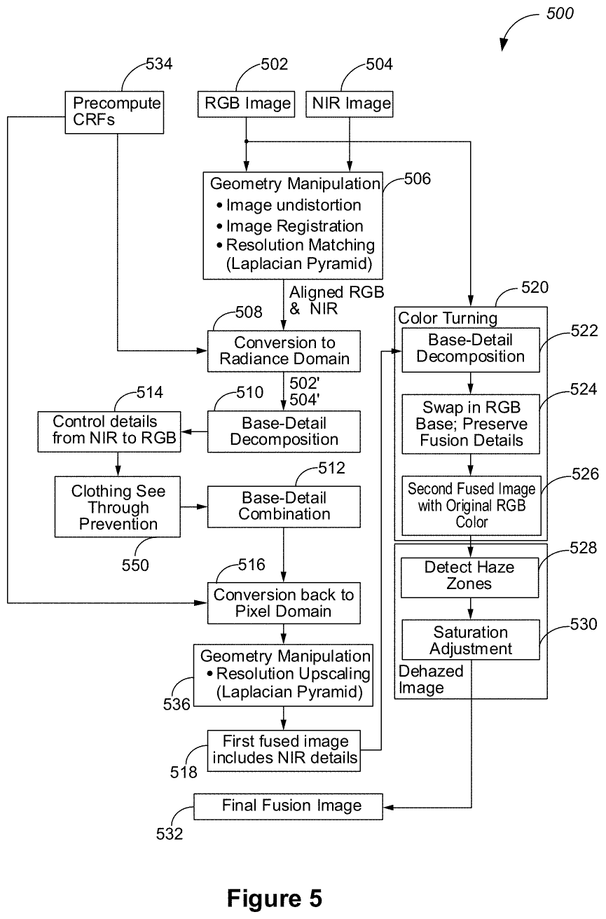

FIG. 5 is an example framework 500 of fusing an RGB image 502 and an NIR image 504, in accordance with some embodiments. The RGB image 502 and NIR image 504 are captured simultaneously in a scene by a camera or two distinct cameras (specifically, by an NIR image sensor and a visible light image sensor of the same camera or two distinct cameras). One or more geometric characteristics of the NIR image and the RGB image are manipulated (506), e.g., to reduce a distortion level of at least a portion of the RGB and NIR images 502 and 504, to transform the RGB and NIR image 502 and 504 into the same coordinate system associated with the scene. In some embodiments, a field of the view of the NIR image sensor is substantially identical to that of the visible light image sensor. Alternatively, in some embodiments, the fields of view of the NIR and visible light image sensors are different, and at least one of the NIR and RGB images is cropped to match the fields of view. Matching resolution are desirable, but not necessary. In some embodiments, the resolution of at least one of the RGB and NIR images 502 and 504 is adjusted to match their resolutions, e.g., using a Laplacian pyramid.

The normalized RGB image 502 and NIR image 504 are converted (508) to a RGB image 502′ and a first NIR image 504′ in a radiance domain, respectively. In the radiance domain, the first NIR image 504′ is decomposed (510) to an NIR base portion and an NIR detail portion, and the first RGB image 502′ is decomposed (510) to an RGB base portion and an RGB detail portion. In an example, a guided image filter is applied to decompose the first RGB image 502′ and/or the first NIR image 504′. A weighted combination 512 of the NIR base portion, RGB base portion, NIR detail portion and RGB detail portion is generated using a set of weights. Each weight is manipulated to control how much of a respective portion is incorporated into the combination. Particularly, a weight corresponding to the NIR base portion is controlled (514) to determine how much of detail information of the first NIR image 514′ is utilized. The weighted combination 512 in the radiance domain is converted (516) to a first fused image 518 in an image domain (also called “pixel domain”). This first fused image 518 is optionally upscaled to a higher resolution of the RGB and NIR images 502 and 504 using a Laplacian pyramid. By these means, the first fused image 518 maintains original color information of the RGB image 502 while incorporating details from the NIR image 504.

In some embodiments, the set of weights used to obtain the weighted combination 512 includes a first weight, a second weight, a third weight and a fourth weight corresponding to the NIR base portion, NIR detail portion, RGB base portion and RGB detail portion, respectively. The second weight corresponding to the NIR detail portion is greater than the fourth weight corresponding to the RGB detail portion, thereby allowing more details of the NIR image 504 to be incorporated into the RGB image 502. Further, in some embodiments, the first weight corresponding to the NIR base portion is less than the third weight corresponding to the RGB base portion. Additionally, in some embodiments not shown in FIG. 5, the first NIR image 504′ includes an NIR luminance component, and the first RGB image 502′ includes an RGB luminance component. An infrared emission strength is determined based on the NIR and RGB luminance components. At least one of the set of weights is generated based on the infrared emission strength, such that the NIR and RGB luminance components are combined based on the infrared emission strength.

In some embodiments, a Camera Response Function (CRF) is computed (534) for the camera(s). The CRF optionally includes separate CRF representations for the RGB image sensor and the NIR image sensor. The CRF representations are applied to convert the RGB and NIR images 502 and 504 to the radiance domain and convert the weighted combination 512 back to the image domain after image fusion. Specifically, the normalized RGB and NIR images are converted to the first RGB and NIR images 502′ and 504′ in accordance with the CRF of the camera, and the weighted combination 512 is converted to the first fused image 518 in accordance with the CRF of the camera(s).

In some embodiments, before the first RGB and NIR images 502′ and 504′ are decomposed, their radiance levels are normalized. Specifically, it is determined that the first RGB image 502′ has a first radiance covering a first dynamic range and that the first NIR image 504′ has a second radiance covering a second dynamic range. In accordance with a determination that the first dynamic range is greater than the second dynamic range, the first NIR image 504′ is modified, i.e., the second radiance of the first NIR image 504′ is mapped to the first dynamic range. Conversely, in accordance with a determination that the first dynamic range is less than the second dynamic range, the first RGB image 502′ is modified, i.e., the first radiance of the first RGB image 502′ is mapped to the second dynamic range.

In some embodiments, a weight in the set of weights (e.g., the weight of the NIR detail portion) corresponds to a respective weight map configured to control different regions separately. The NIR image 504 includes a portion having details that need to be hidden, and the weight corresponding to the NIR detail portion includes one or more weight factors corresponding to the portion of the NIR detail portion. An image depth of the region of the first NIR image is determined. The one or more weight factors are determined based on the image depth of the region of the first NIR image. The one or more weight factors corresponding to the region of the first NIR image are less than a remainder of the second weight corresponding to a remaining portion of the NIR detail portion. As such, the region of the first NIR image is protected (550) from a see-through effect that could potentially cause a privacy concern in the first fusion image.

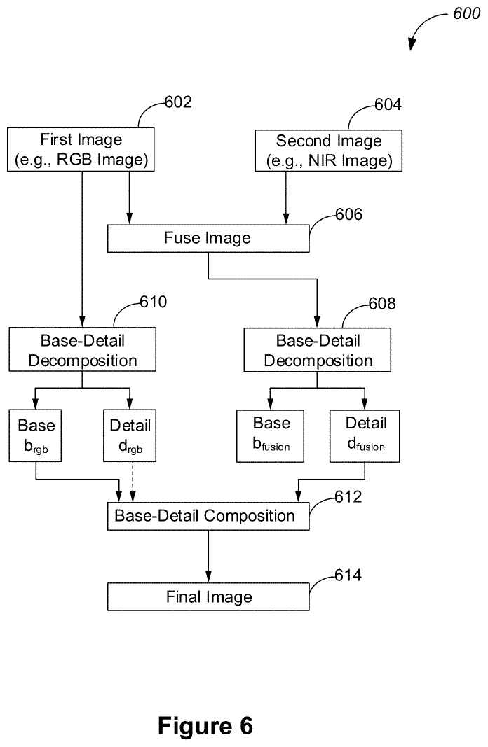

Under some circumstances, the first fused image 518 is processed using a post processing color tuning module 520 to tune its color. The original RGB image 502 is fed into the color tuning module 520 as a reference image. Specifically, the first fused image 518 is decomposed (522) into a fused base portion and a fused detail portion, and the RGB image 502 is decomposed (522) into a second RGB base portion and a second RGB detail portion. The fusion base portion of the first fused image 518 is swapped (524) with the second RGB base portion. Stated another way, the fused detail portion is preserved (524) and combined with the second RGB base portion to generate a second fused image 526. In some embodiments, color of the first fused image 518 deviates from original color of the RGB image 502 and looks unnatural or plainly wrong, and a combination of the fused detail portion of the first fused image 518 and the second RGB base portion of the RGB image 502 (i.e., the second fused image 526) can effectively correct color of the first fused image 518. More details on color tuning of a fused image are discussed below with reference to FIG. 6.

Alternatively, in some embodiments not shown in FIG. 5, color of the first fused image 518 is corrected based on a plurality of color channels in a color space. A first color channel (e.g., a blue channel) is selected from the plurality of color channels as an anchor channel. An anchor ratio is determined between a first color information item and a second color information item that correspond to the first color channel of the first RGB 502′ and the first fused image 518, respectively. For each of one or more second color channels (e.g., a red channel, a green channel) distinct from the first color channel, a respective corrected color information item is determined based on the anchor ratio and at least a respective third information item corresponding to the respective second color channel of the first RGB image 502′. The second color information item of the first color channel of the first fused image and the respective corrected color information item of each of the one or more second color channels to generate a third fused image.

In some embodiments, the first fused image 518 or second fused image 526 is processed (528) to dehaze the scene to see through fog and haze. For example, one or more hazy zones are identified in the first fused image 518 or second fused image 526. A predefined portion of pixels (e.g., 0.1%, 5%) having minimum pixel values are identified in each of the one or more hazy zones, and locally saturated to a low-end pixel value limit. Such a locally saturated image is blended with the first fused image 518 or second fused image 526 to form a final fusion image 532 which is properly dehazed while having enhanced NIR details with original RGB color. A saturation level of the final fusion image 532 is optionally adjusted (530) after the haze is removed locally (528). Conversely, in some embodiments, the RGB image 502 is pre-processed to dehaze the scene to see through fog and haze prior to being converted (508) to the radiance domain or decomposed (510) to the RGB detail and base portions. Specifically, one or more hazy zones are identified in the RGB image 502 that may or may not have been geometrically manipulated. A predefined portion of pixels (e.g., 0.1%, 5%) having minimum pixel values are identified in each of the one or more hazy zones of the RGB image 502, and locally saturated to a low-end pixel value limit. The locally saturated RGB image is geometrically manipulated (506) and/or converted (508) to the radiance domain.

In some embodiments, the framework 500 is implemented at an electronic device (e.g., 200 in FIG. 2) in accordance with a determination that the electronic device operates in a high dynamic range (HDR) mode. Each of the first fused image 518, second fused image 526, and final fusion image 532 has a greater HDR than the RGB image 502 and NIR image 504. The set of weights used to combine the base and detail portions of the RGB and NIR images are determined to increase the HDRs of the RGB and NIR images. In some situations, the set of weights corresponds to optimal weights that result in a maximum HDR for the first fused image. However, in some embodiments, it is difficult to determine the optimal weights, e.g., when one of the RGB and NIR images 502 and 504 is dark while the other one of the RGB and NIR images 502 and 504 is bright due to their differences in imaging sensors, lens, filters, and/or camera settings (e.g., exposure time, gain). Such a brightness difference is sometimes observed in the RGB & NIR images 502 and 504 that are taken in a synchronous manner by image sensors of the same camera. In this application, two images are captured in a synchronously manner when the two images are captured concurrently or within a predefined duration of time (e.g., within 2 seconds, within 5 minutes), subject to the same user control action (e.g., a shutter click) or two different user control actions.

It is noted that each of the RGB and NIR images 502 and 504 can be in a raw image format or any other image format. Broadly speaking, in some embodiments, the framework 500 applies to two images that are not limited to the RGB and NIR images 502 and 504. For example, a first image and a second image are captured for a scene by two different sensor modalities of a camera or two distinct cameras in a synchronous manner. After one or more geometric characteristics are normalized for the first image and the second image, the normalized first image and the normalized second image are converted to a third image and a fourth image in a radiance domain, respectively. The third image is decomposed to a first base portion and a first detail portion, and the fourth image is decomposed to a second base portion and a second detail portion. A weighted combination of the first base portion, first base portion, second detail portion and second detail portion using a set of weights. The weighted combination in the radiance domain is converted to a first fused image in an image domain. Likewise, in different embodiments, image registration, resolution matching, and color tuning may be applied to the first and second images.

A color image and an NIR image are fused to a compact form of image that contains more information than either one of the color and NIR images. This compact form of image contains more details than either input image, and however, its color may deviate greatly from the RGB image or from the reality. In some embodiments of this application, a fused image is decomposed into base and detail portions. A detail portion of the fused image is extracted and added onto the color image to obtain a final image, thereby causing color of the final image to be substantially consistent with that of the color image while still preserving details of the fusion image. By these means, any fused image can be modified to tune its color towards its original color image, and the corresponding final image looks natural, sees through fog or haze, and have a high dynamic range with color and image details derived from multiple sensor modalities.

FIG. 6 is another example framework 600 of fusing two images 602 and 604, e.g., for correcting color of a fused image 606 generated from the two images 602 and 604, in accordance with some embodiments. A first image 602 and a second image 604 are captured simultaneously in a scene. In an example, the first and second images 602 and 604 include an RGB image and an NIR image that are captured by an NIR image sensor and a visible light image sensor of the same camera, respectively. In another example, the first and second images 602 and 604 include an RGB image and an NIR image that are captured by a visible light camera and an NIR camera, respectively, and the NIR and visible light cameras cover the same scene. To match the two images 602 and 604, view cropping is optionally applied on one or both of the two images 602 and 604, and resolutions of the two images 602 and 604 are optionally identical or different. After the images 602 and 604 are captured, they are processed and fused into a new compact form of image, i.e., the fused image 605, that contains details from both images 602 and 604. The fused image 605 is then tuned towards color of the first image 602, e.g., an original input RGB image, while preserving details of the fused image 606.

Specifically, the first image 602 and the second image 604 are combined to generate the fused image 606. The fused image 606 is decomposed (608) to a fusion base component b_{fusion} and a fusion detail component d_{fusion}, e.g., using a first guided image filter. The first image 602 is decomposed (610) to a first base component b_{rgb} and a first detail component d_{rgb}, e.g., using a second guided image filter. In some embodiments, the fusion base and detail components b_{fusion} and d_{fusion} include low-frequency and high-frequency information of the fusion image 606, and the first base and detail components b_{rgb} and d_{rgb} include low-frequency and high-frequency information of the first image 602. The first base component b_{rgb} of the first image 602 and the fusion detail component d_{fusion} of the fused image 606 are combined (612) to a final image 614, which thereby maintains a base color of the first image 602 while having details of the fused image 606. In some embodiments, the first base component b_{rgb}, the first detail component d_{rgb}, and the fusion detail component d_{fusion} are combined to the final image 614, e.g., using a plurality of weights. When the first image 602 is an RGB image and the second image 604 is an NIR image, the first base component b_{rgb} of the RGB image and the fusion detail component d_{fusion} of the fused image are combined to the final image 614 with or without the first detail component d_{rgb}.

Amount or strength of image details in the final image 614 can be adjusted through the detail components d_{rgb} and d_{fusion} that are optionally controlled through parameters of each guided image filter. For example, a target ratio of the first detail component d_{rgb} and the fusion detail component d_{fusion} is determined for combining the first base component b_{rgb}, the first detail component d_{rgb}, and the fusion detail component d_{fusion} to the on the final image 614. The fused image 606 is decomposed using a first guided image filter having first filter parameters, and the first image 602 is decomposed using a second guided image filter having second filter parameters. The first and second filter parameters are adjusted based on the target ratio such that the first detail component d_{rgb} and the fusion detail component d_{fusion} are generated as desired.

In some embodiments, the fused image 606 has a first haze level and a first dynamic range, and the final image 614 has a second haze level and a second dynamic range. The second haze level is lower than the first haze level, and the second dynamic range is greater than the first dynamic range. By these means, the framework 600 is configured to reduce the haze level and improve the dynamic range of the fused image 606.

The first and second images 602 and 604 may be fused by various methods. For example, referring to FIG. 5, the first and second images 602 and 604 are converted to a radiance domain, and decomposed to a first base portion, a first detail portion, a second base portion, and a second detail portion. The first base portion, first detail portion, second base portion, and second detail portion are combined using a set of weights. A weighted combination is converted from the radiance domain to the fused image 606 in an image domain. A subset of the weights is optionally increased to preserve details of the first image 602 or second image 604. Alternatively, in some embodiments, radiances of the first and second images 602 and 604 are matched and combined to generate a fused radiance image, which is further converted to the fused image 606 in the image domain. The fused radiance image optionally includes grayscale or luminance information of the first and second images 602 and 604, and is combined with color information of the first image 602 or second image 604 to obtain the fused image 606 in the image domain. Alternatively, in some embodiments, an infrared emission strength is determined based on luminance components of the first and second images 602 and 604. The luminance components of the first and second images 602 and 604 are combined based on the infrared emission strength. Such a combined luminance component is further merged with color components of the first image 602 to obtain the fused image 606.

In accordance with some embodiments implemented by the framework 600, an RGB image and an NIR image of a scene are obtained. A fused image 606 is generated to combine the RGB and NIR images. The fused image 606 is decomposed to a fusion base component b_{fusion} and a fusion detail component d_{fusion}. The RGB image 602 is decomposed to a first base component b_{rgb} and a first detail component d_{rgb}. The first base component b_{rgb} of the RGB image and the fusion detail component d_{fusion} of the fused image 606 are combined to a final image 614.

The first image 602 and second image 604 are optionally pre-processed before being combined to the fused image 606, and the final image 614 is optionally processed after being combined from the first and fused images 602 and 606. In some embodiments not shown in FIG. 6, one or more geometric characteristics of the first and second images 602 and 604 are normalized by reducing a distortion level of at least a portion of the first and second images 602 and 604, transforming the first and second images 602 and 604 into a coordinate system associated with a field of view, or matching resolutions of the first and second images 602 and 604 (e.g., using a Laplacian pyramid). In some embodiments, color characteristics are the final image 614 is tuned in an image domain. The color characteristics of the final image 614 include at least one of color intensities and a saturation level of the final image 614. In some embodiments, one or more hazy zones are identified in the first image 602 or final image 614. White balance is adjusted for each of the one or more hazy zones locally, e.g., by saturating a predefined portion (e.g., 0.1%, 5%) of pixels in each of the one or more hazy zones to a low-end pixel value limit (e.g., 0).

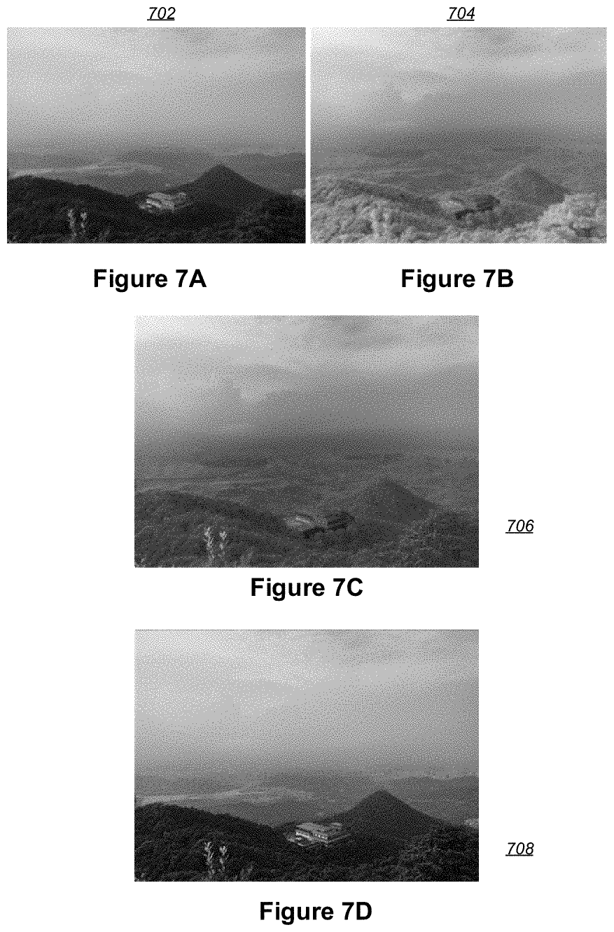

FIGS. 7A-7D are an RGB image 702, an NIR monochrome image 704, a fused image 706 combining the RGB image 702 and NIR monochrome image 705, and a final image 708 generated by the framework 600 shown in FIG. 6 in accordance with some embodiments. That said, the final image 708 is generated by combining a first base portion b_{rgb} of the RGB image 702 and a fusion detail portion d_{fusion} of the fused image 706. The fused image 706 has a color deviation from the RGB image 702. In the final image 708, color of the fused image 706 is corrected towards color of the RGB image 702, while details of the fused image 706 have been substantially preserved.

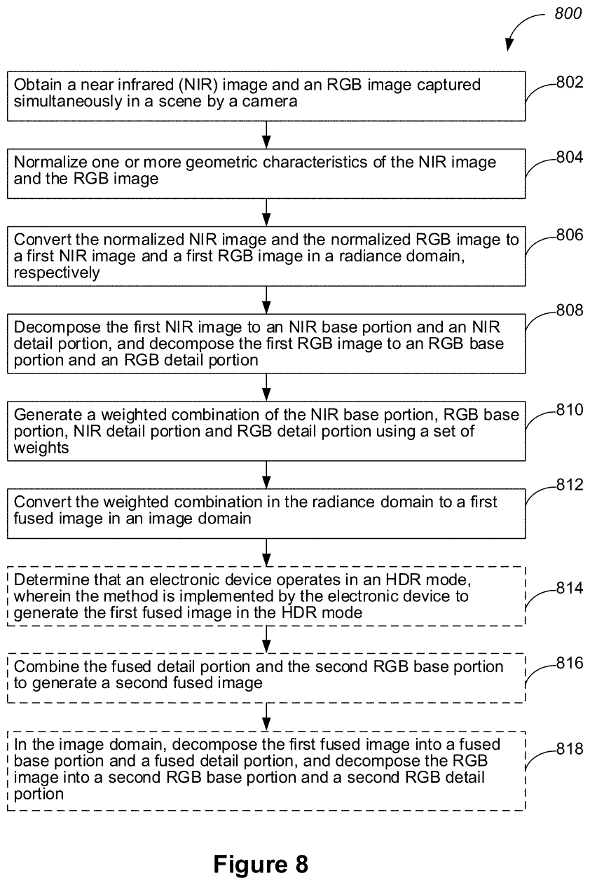

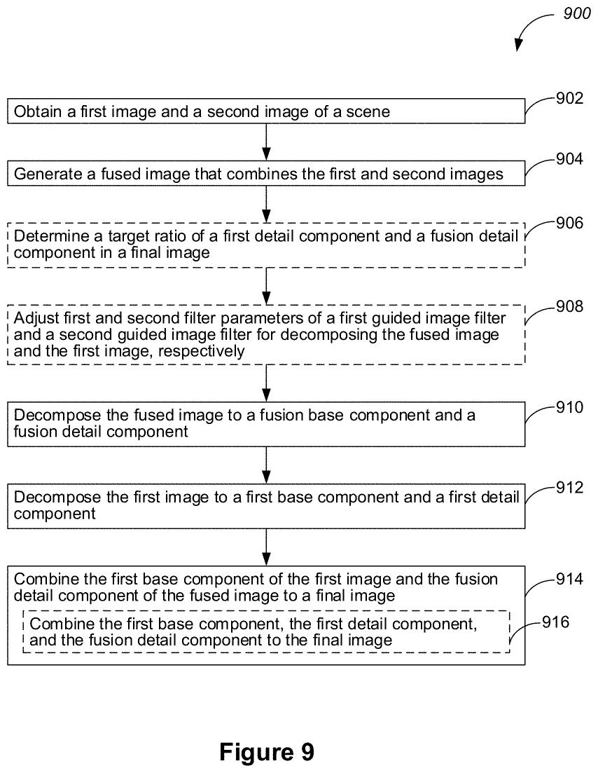

FIGS. 8 and 9 are flow diagrams of image processing methods 800 and 900 implemented at a computer system, in accordance with some embodiments. Each of the methods 800 and 900 is, optionally, governed by instructions that are stored in a non-transitory computer readable storage medium and that are executed by one or more processors of the computer system (e.g., a server 102, a client device 104, or a combination thereof). Each of the operations shown in FIGS. 8 and 9 may correspond to instructions stored in the computer memory or computer readable storage medium (e.g., memory 206 in FIG. 2) of the computer system 200. The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. Some operations in the methods 800 and 900 may be combined and/or the order of some operations may be changed. More specifically, each of the methods 800 and 900 is governed by instructions stored in an image processing module 250, a data processing module 228, or both in FIG. 2.

FIG. 8 is a flow diagram of an image fusion method 800 implemented at a computer system 200 (e.g., a server 102, a client device, or a combination thereof), in accordance with some embodiments. Referring to both FIGS. 5 and 8, the computer system 200 obtains (802) an NIR image 504 and an RGB image 502 captured simultaneously in a scene (e.g., by different image sensors of the same camera or two distinct cameras), and normalizes (804) one or more geometric characteristics of the NIR image 504 and the RGB image 502. The normalized NIR image and the normalized RGB image are converted (806) to a first NIR image 504′ and a first RGB image 502′ in a radiance domain, respectively. The first NIR image 504′ is decomposed (808) to an NIR base portion and an NIR detail portion, and the first RGB image 502′ is decomposed (808) to an RGB base portion and an RGB detail portion. The computer system generates (810) a weighted combination 512 of the NIR base portion, RGB base portion, NIR detail portion and RGB detail portion using a set of weights, and converts (812) the weighted combination 512 in the radiance domain to a first fused image 518 in an image domain. In some embodiments, the NIR image 504 has a first resolution, and the RGB image 502 has a second resolution. The first fused image 518 is upscaled to a larger resolution of the first and second solutions using a Laplacian pyramid.

In some embodiments, the computer system determines a CRF for the camera. The normalized NIR and RGB images are converted to the first NIR and RGB images 504′ and 502′ in accordance with the CRF of the camera. The weighted combination 512 is converted to the first fused image 518 in accordance with the CRF of the camera. In some embodiments, the computer system determines (814) that it operates in a high dynamic range (HDR) mode. The method 800 is implemented by the computer system to generate the first fused image 518 in the HDR mode.

In some embodiments, the one or more geometric characteristics of the NIR image 504 and the RGB image 502 are manipulated by reducing a distortion level of at least a portion of the RGB and NIR images 502 and 504, implementing an image registration process to transform the NIR image 504 and the RGB image 502 into a coordinate system associated with the scene, or matching resolutions of the NIR image 504 and the RGB image 502.

In some embodiments, prior to decomposing the first NIR image 504′ and decomposing the first RGB image 502′, the computer system determines that the first RGB image 502′ has a first radiance covering a first dynamic range and that the first NIR image 504′ has a second radiance covering a second dynamic range. In accordance with a determination that the first dynamic range is greater than the second dynamic range, the computer system modifies the first NIR image 504′ by mapping the second radiance of the first NIR image 504′ to the first dynamic range. In accordance with a determination that the first dynamic range is less than the second dynamic range, the electronic device modifies the first RGB image 502′ by mapping the first radiance of the first RGB image 502′ to the second dynamic range.

In some embodiments, the set of weights includes a first weight, a second weight, a third weight and a fourth weight corresponding to the NIR base portion, NIR detail portion, RGB base portion and RGB detail portion, respectively. The second weight is greater than the fourth weight. Further, in some embodiments, the first NIR image 504′ includes a region having details that need to be hidden, and the second weight corresponding to the NIR detail portion includes one or more weight factors corresponding to the region of the NIR detail portion. The computer system determines an image depth of the region of the first NIR image 504′ and determines the one or more weight factors based on the image depth of the region of the first NIR image 504′. The one or more weight factors corresponding to the region of the first NIR image are less than a remainder of the second weight corresponding to a remaining portion of the NIR detail portion.

In some embodiments, the computer system tune color characteristics of the first fused image in the image domain. The color characteristics of the first fused image include at least one of color intensities and a saturation level of the first fused image 518. In some embodiments, in the image domain, the first fused image 518 is decomposed (816) into a fused base portion and a fused detail portion, and the RGB image 502 is decomposed (818) into a second RGB base portion and a second RGB detail portion. The fused detail portion and the second RGB base portion are combined (816) to generate a second fused image. In some embodiments, one or more hazy zones are identified in the first fused image 518 or the second fused image, such that white balance of the one or more hazy zones is adjusted locally. Specifically, in some situations, the computer system detects one or more hazy zones in the first fused image 518, and identifies a predefined portion of pixels having minimum pixel values in each of the one or more hazy zones. The first fused image 518 is modified to a first image by locally saturating the predefined portion of pixels in each of the one or more hazy zones to a low-end pixel value limit. The first fused image 518 and the first image are blended to form a final fusion image 532. Alternatively, in some embodiments, one or more hazy zones are identified in the RGB image 502, such that white balance of the one or more hazy zones is adjusted locally by saturating a predefined portion of pixels in each hazy zone to the low-end pixel value limit.

FIG. 9 is a flow diagram of another image processing method 900 implemented at a computer system 200 (e.g., a server 102, a client device, or a combination thereof), in accordance with some embodiments. Referring to FIGS. 6 and 9, the computer system 200 obtains (902) a first image 602 and a second image 604 of a scene. In some embodiments, the first image 602 includes an RGB image, and the second image 604 includes an NIR image. The RGB image and the NIR image are captured in a synchronous manner (e.g., by different image sensors of the same camera or two distinct cameras). A fused image 606 is generated (904) by combining the first and second images 602 and 604. The computer system 200 decomposes (910) the fused image 606 to a fusion base component b_{fusion} and a fusion detail component d_{fusion}, and decomposes (912) the first image to a first base component b_{rgb} and a first detail component d_{rgb}. The first base component b_{rgb} of the first image 602 and the fusion detail component d_{fusion} of the fused image 606 are combined (914) to a final image 614.

In some embodiments, the first detail component d_{rgb} is also combined into the final image 614, i.e., the first base component b_{rgb}, the first detail component d_{rgb}, and the fusion detail component d_{fusion} are combined (916) to the final image 614. Further, in some embodiments, the fused image 606 is decomposed using a first guided image filter having first filter parameters, and the first image is decomposed using a second guided image filter having second filter parameters. The computer system 200 determines (906) a target ratio of the first detail component d_{rgb} and the fusion detail component d_{fusion}. The first and second filter parameters are adjusted (908) based on the target ratio. When the first base component b_{rgb}, the first detail component d_{rgb}, and the fusion detail component d_{fusion} are generated by the guided image filters, they comply with the target ratio and result in the final image 614 as intended.

In some embodiments, the fused image 606 has a first haze level and a first dynamic range, and the final image 614 has a second haze level and a second dynamic range. The second haze level is lower than the first haze level, and the second dynamic range is greater than the first dynamic range.

It should be understood that the particular order in which the operations in each of FIGS. 8 and 9 have been described are merely exemplary and are not intended to indicate that the described order is the only order in which the operations could be performed. One of ordinary skill in the art would recognize various ways to process images as described in this application. Additionally, it should be noted that details described above with respect to FIGS. 5-7 are also applicable in an analogous manner to each of the methods 800 and 900 described above with respect to FIGS. 8 and 9. For brevity, these details are not repeated for every figure in FIGS. 8 and 9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the embodiments described in the present application. A computer program product may include a computer-readable medium.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, elements, and/or components, but do not preclude the presence or addition of one or more other features, elements, components, and/or groups thereof.

It will also be understood that, although the terms first, second, etc. may be used herein to describe various elements, these elements should not be limited by these terms. These terms are only used to distinguish one element from another. For example, a first electrode could be termed a second electrode, and, similarly, a second electrode could be termed a first electrode, without departing from the scope of the embodiments. The first electrode and the second electrode are both electrodes, but they are not the same electrode.

The description of the present application has been presented for purposes of illustration and description, and is not intended to be exhaustive or limited to the invention in the form disclosed. Many modifications, variations, and alternative embodiments will be apparent to those of ordinary skill in the art having the benefit of the teachings presented in the foregoing descriptions and the associated drawings. The embodiment was chosen and described in order to best explain the principles of the invention, the practical application, and to enable others skilled in the art to understand the invention for various embodiments and to best utilize the underlying principles and various embodiments with various modifications as are suited to the particular use contemplated. Therefore, it is to be understood that the scope of claims is not to be limited to the specific examples of the embodiments disclosed and that modifications and other embodiments are intended to be included within the scope of the appended claims.

What is claimed is:

1. An image processing method, comprising:
obtaining a first image and a second image of a scene;
generating a fused image that combines the first image and the second image;
decomposing the fused image to a fusion base component and a fusion detail component;
decomposing the first image to a first base component and a first detail component; and
combining the first base component of the first image and the fusion detail component of the fused image to a final image.

2. The method of claim 1, wherein combining the first base component of the first image and the fusion detail component of the fused image to the final image comprises:
combining the first base component, the first detail component, and the fusion detail component to the final image.

3. The method of claim 2, wherein the fused image is decomposed using a first guided image filter having first filter parameters, and the first image is decomposed using a second guided image filter having second filter parameters, and the method further comprises:
determining a target ratio of the first detail component and the fusion detail component; and
adjusting the first filter parameters and the second filter parameters based on the target ratio.

4. The method of claim 1, wherein the fused image has a first haze level and a first dynamic range, and the final image has a second haze level and a second dynamic range, the second haze level being lower than the first haze level, the second dynamic range being greater than the first dynamic range.

5. The method of claim 1, wherein the first image includes an RGB image, and the second image includes a near infrared (NIR) image.

6. The method of claim 5, wherein the RGB image and the NIR image are captured by a camera in a synchronous manner.

7. The method of claim 1, further comprising:
identifying one or more hazy zones in the first image or the final image; and
adjusting white balance of the one or more hazy zones locally.

8. The method of claim 1, further comprising normalizing one or more geometric characteristics of the first image and the second image by one or more of:
reducing a distortion level of at least a portion of the first image and the second image;
implementing an image registration process to transform the first image and the second image into a coordinate system associated with the scene; and
matching resolutions of the first image and the second image.

9. The method of claim 1, wherein generating the fused image that combines the first image and the second image comprises:
converting the first image and the second image to a radiance domain;
decomposing the converted first image to a first base portion and a first detail portion, and decomposing the converted second image to a second base portion and a second detail portion;
generating a weighted combination of the first base portion, the second base portion, the first detail portion, and the second detail portion using a set of weights; and
converting the weighted combination in the radiance domain to the fused image in an image domain.

10. The method of claim 1, wherein generating the fused image that combines the first image and the second image comprises:
matching radiances of the first image and the second image;
combining the radiances of the first image and the second image to generate a fused radiance image; and
converting the fused radiance image to the fused image in an image domain.

11. The method of claim 1, wherein generating the fused image that combines the first image and the second image comprises:
extracting a first luminance component and a first color component from a re-aligned first image;
extracting a second luminance component from a re-aligned second image;
determining an infrared emission strength based on the first luminance component and the second luminance component;
combining the first luminance component and the second luminance component based on the infrared emission strength to obtain a combined luminance component; and
combining the combined luminance component with the first color component to obtain the fused image.

12. A computer system, comprising:
one or more processors; and
a memory having instructions stored thereon, which when executed by the one or more processors cause the one or more processors to:
obtain a first image and a second image of a scene;
generate a fused image that combines the first image and the second image;
decompose the fused image to a fusion base component and a fusion detail component;
decompose the first image to a first base component and a first detail component; and
combine the first base component of the first image and the fusion detail component of the fused image to a final image.

13. The computer system of claim 12, wherein the one or more processors configured to combine the first base component of the first image and the fusion detail component of the fused image to the final image are configured to:
combine the first base component, the first detail component, and the fusion detail component to the final image.

14. The computer system of claim 12, wherein the fused image is decomposed using a first guided image filter having first filter parameters, and the first image is decomposed using a second guided image filter having second filter parameters, and the instructions further cause the one or more processors to:
determine a target ratio of the first detail component and the fusion detail component; and
adjust the first filter parameters and the second filter parameters based on the target ratio.

15. The computer system of claim 12, wherein the fused image has a first haze level and a first dynamic range, and the final image has a second haze level and a second dynamic range, the second haze level being lower than the first haze level, the second dynamic range being greater than the first dynamic range.

16. The computer system of claim 12, wherein the first image includes an RGB image, and the second image includes a near infrared (NIR) image.

17. The computer system of claim 16, wherein the RGB image and the NIR image are captured by a camera in a synchronous manner.

18. The computer system of claim 12, wherein the instructions further cause the one or more processors to:
identify one or more hazy zones in the first image or the final image; and
adjust white balance of the one or more hazy zones locally.

19. The computer system of claim 12, wherein the instructions further cause the one or more processors to normalize one or more geometric characteristics of the first image and the second image by one or more of:
reducing a distortion level of at least a portion of the first image and the second image;
implementing an image registration process to transform the first image and the second image into a coordinate system associated with the scene; and
matching resolutions of the first image and the second image.

20. A non-transitory computer-readable medium, having instructions stored thereon, which when executed by one or more processors cause the one or more processors to:
obtain a first image and a second image of a scene;
generate a fused image that combines the first image and the second image;
decompose the fused image to a fusion base component and a fusion detail component;
decompose the first image to a first base component and a first detail component; and
combine the first base component of the first image and the fusion detail component of the fused image to a final image.
